(19) United States
(12) Patent Application Publication
(10) Pub. No.: US 2014/0308475 A1
(43) Pub. Date: Oct. 16, 2014

(54) CAMOUFLAGE DEVICE

(71) Applicant: Shawn O'Connor, Ankeny, IA (US)

(72) Inventor: Shawn O'Connor, Ankeny, IA (US)

(21) Appl. No.: 14/247,302

(22) Filed: Apr. 8, 2014

Related U.S. Application Data
(60) Provisional application No. 61/811,517, filed on Apr. 12, 2013.

(51) Int. Cl. A01M 31/00

(52) U.S. Cl. CPC A01M 31/002
USPC 428/100; 428/99; 428/131; 428/343; 442/1

(57) ABSTRACT

A camouflage device includes a plurality of threads connected together to form a plurality of strips. The plurality of strips are connected to a hunting device using an attachment device. The strips are attached to the hunting device in overlapping rows to substantially cover the hunting device.

### CROSS REFERENCE TO RELATED APPLICATION

This application claims the benefit of U.S. Provisional Application No. 61/811,517 filed Apr. 12, 2013.

### BACKGROUND OF THE INVENTION

The present invention relates to a device for covering a trail camera and more particularly, to a device that provides a three-dimensional camouflage to the trail camera.

A trail camera is a device that records images, either as a still photograph or a video. The camera is a rugged and weatherproof device designed for extended and unmanned use outdoors. The images produced are used for game surveillance by hunters. The trail camera automatically takes a picture when it senses motion. Each image is stamped with the date and time the picture was recorded. The trail camera functions day and night by sensing game out to around 45 feet.

Trail cameras are difficult to conceal. Their boxy appearance and straight lines are not natural and stand out against vegetation. Their high selling price and demand also makes them a target for thieves. Current techniques to disguise a trail camera involve printing camouflage designs on the camera itself. This results in a two-dimensional disguise that helps the camera blend with natural colors but only slightly improves its concealment as the object is still readily recognizable given its straight lines and boxy appearance.

As can be seen, there is a need for a better camouflaging device.

An objective of the present invention is to provide a cover for a hunting device that improves concealment of the camera.

A further objective of the present invention is to provide a cover for a hunting device that is easy to attach.

These and other objectives will be apparent to one of ordinary skill in the art based upon the following written description, drawings, and claims.

### BRIEF SUMMARY OF THE INVENTION

A camouflage device includes a plurality of threads connected together to form a plurality of strips. The plurality of strips are connected to a hunting device using an attachment device. The strips are attached to the hunting device in overlapping rows to substantially cover the hunting device.

Alternatively, the plurality of threads are attached to pieces of material that are cut to a size and shape to fit over a hunting device. At least one aperture is cut from the pieces of material that aligns with a feature of the hunting device when the pieces of material are placed over the hunting device. The pieces of material are connected together so that they slide over the hunting device.

### BRIEF DESCRIPTION OF THE DRAWINGS

FIG. 1 is a front view of a camouflage device;

FIG. 2 is a strip of threads of a camouflage;

FIG. 3 is a front view of a strip of threads applied to a hunting device; and

FIG. 4 is a perspective view of a plurality of threads attached to pieces of material.

### DETAILED DESCRIPTION OF THE PREFERRED EMBODIMENT

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a camouflage device 10 having a plurality of threads 12, attached to a hunting device 14, wherein the plurality of threads 12 substantially covers the hunting device 14.

The present invention may include a three-dimensional camouflage covering 10 to conceal trail cameras 14. The present invention conceals the camera 14 by blending into its surroundings and eliminating the boxy appearance and straight lines of the camera 14. By applying the present invention, the box shape may be eliminated and may be substituted with irregular and random shapes that make the camera 14 more difficult to see and thereby reduces the risk of theft.

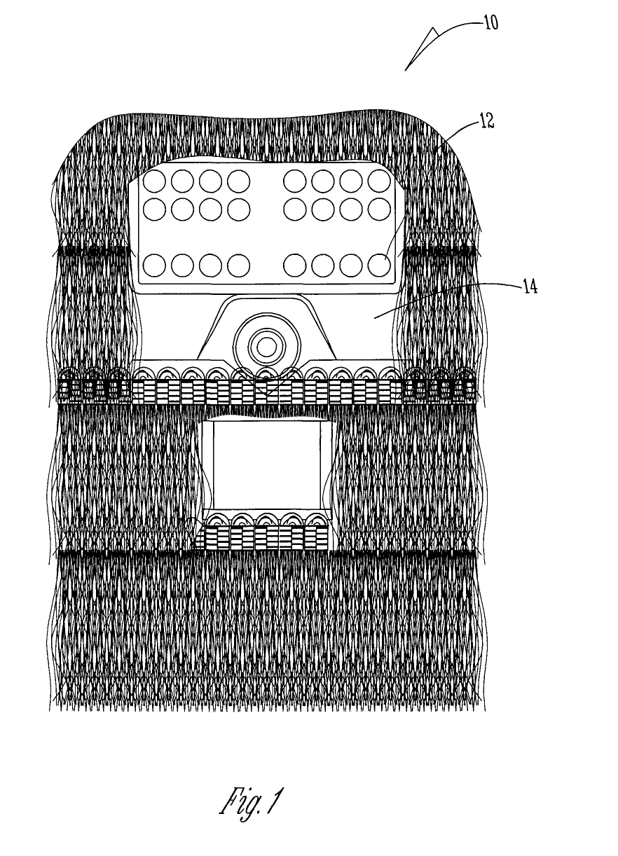

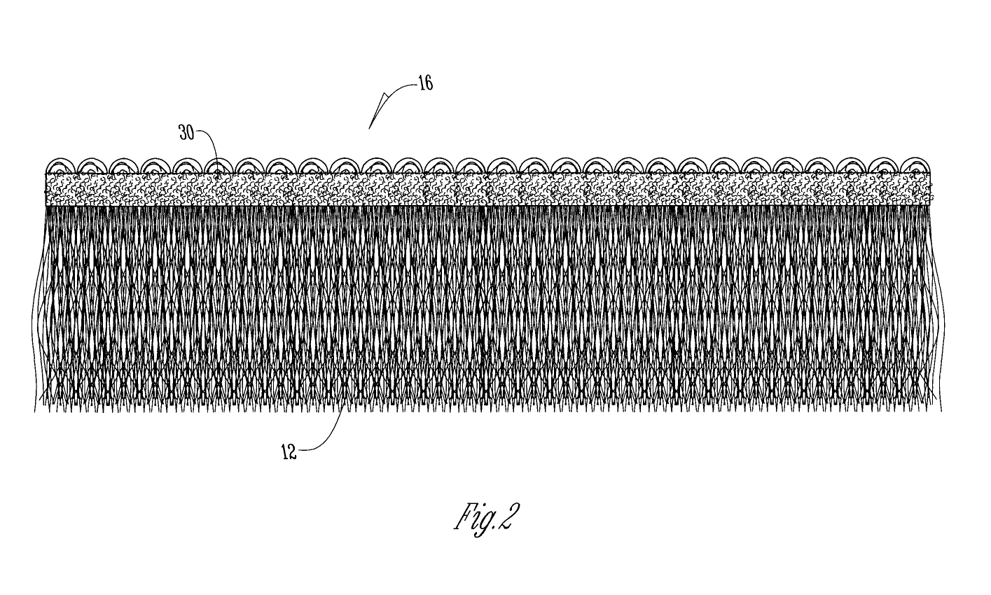

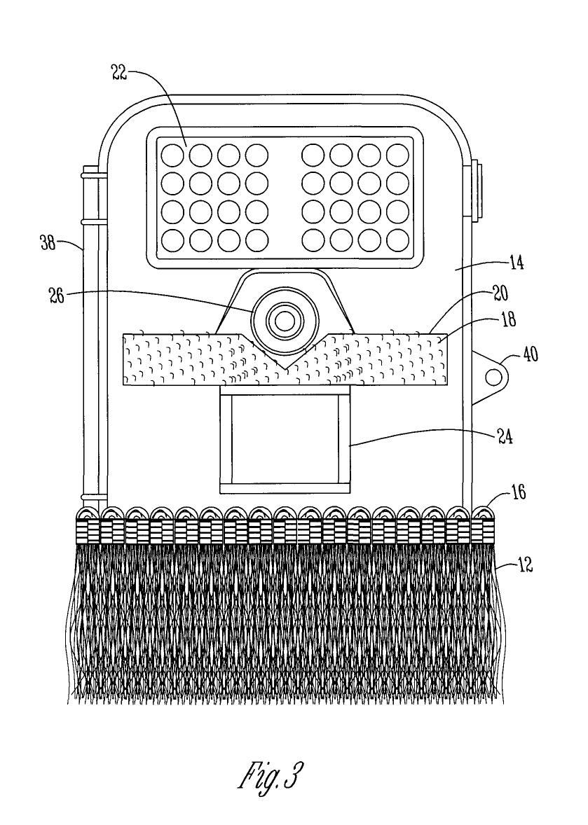

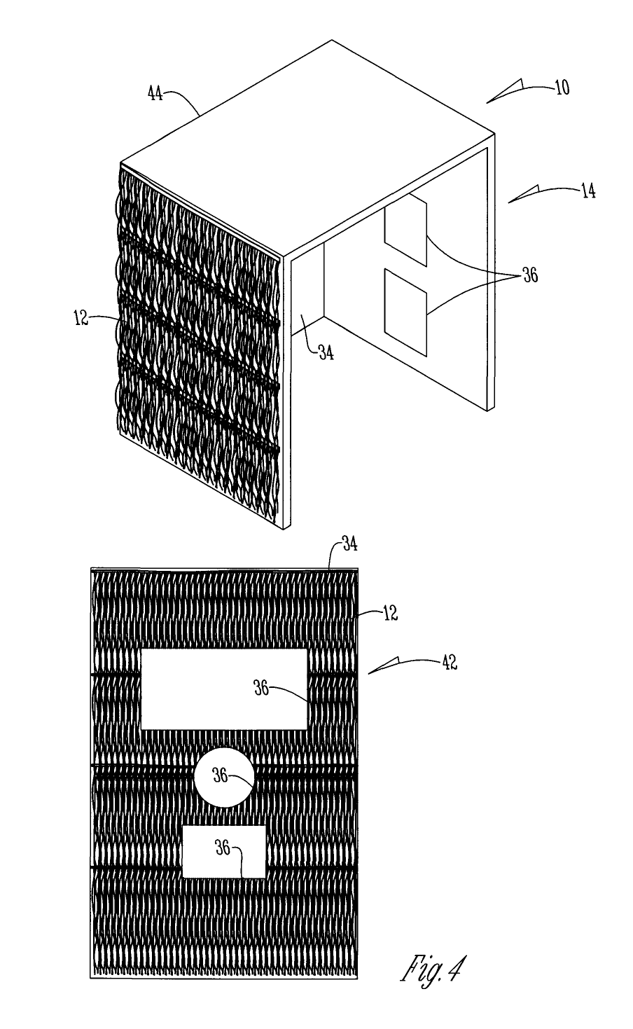

Referring now to FIGS. 1 through 4, the present invention may comprise a plurality of threads 12. In certain embodiments, the plurality of threads 12 may be manufactured into fringe. The threads 12 may be connected together to create a strip 16 of threads 12. An attachment device 18 may be applied to a substantial portion of the length of the strip 16. This may be done by glue, adhesive, elastic band, sewing or the like. In certain embodiments, the attachment device 18 is a loop and hook fastener. In such embodiments, a hook fastener 18 may be applied to the trail camera 14. The loop fastener 18 may be attached to a substantial length of the top of the backside of the strip 16. The hook fastener 18 may be cut to the appropriate length. The covering protecting the adhesive side 20 of the hook fastener 18 may be removed so the hook fastener 18 may be applied to the camera 14.

When in use, the strip 18 may be cut to the appropriate length and secured onto the trail camera 14 with loop fastener 18 adhering to the hook fastener 18. Once the first row at the bottom of the camera is in place, additional rows may be added to overlay a portion of the previous row. This is continued until the trail camera is substantially covered. Thread 12 may then be cut to reveal the flash 22, heat sensor 24 and camera lens 26 of the camera 14, which allows the camera 14 to properly function. The combination of the rows of fringe with threads 12 may create a three-dimensional disguise for the trail camera 14, which eliminates straight lines and boxy appearance.

A method of making the present invention may include the following. Spools of thread 12 may be loaded onto a jig. Ends of thread 12 may be fed into a fringe-making machine. The fringe-making machine winds the thread 12 into loops of desired length. The top of the fringe 12 is then sewn to hold the threads 12 together. The bottom loops may be cut to produce fringe. The loop fastener 18 may then be applied to the fringe by glue or sewing. Adhesive hook fastener 18 may be attached to trail camera.

In alternative embodiments, bunches of thread 12 may be sewn or glued onto a substrate 30 and the substrate 30 may be applied to the camera 14. Bunches of thread 12 may be adhered directly to the trail camera 14 surface. Camouflage material 34 may be cut and attached to the trail camera 14. Bunches of thread 12 may be adhered to a sheet of adhesive 34. Sheet 34 is cut to a size and shape to be attached to the hunting device 14. Depending on the hunting device 14, various apertures 26 are cut out of the material 24 such that when the sheet 34 is placed on the hunting device 14, the apertures 26 align with various features of the hunting device 14.

Bunches of thread 12 may be tied to a net substrate 30 and the netting applied to the trail camera 14. The present invention may be adhered to any hunting items to conceal their appearance. Examples include hunting scopes, guns, rifles, bows, quiver, binoculars, clothing, masks, hats, jackets, backpacks, bags, etc.

In another embodiment, the plurality of threads 12 are attached to pieces of material 34. The material 34 is cut to a size and shape to be attached or fit over the hunting device 14. Depending upon the device 14, various apertures 36 are cut out of the material 34 such that when the material 34 is placed on or over the hunting device 14 the aperture 36 align with various features of the hunting device 14. For example, when covering a trail camera 14, the apertures 36 align with the flash 22, the heat sensor 24, and the lens 26 on the front of the camera 14. On the side of the camera 14, apertures 36 align with a hinge 38 or clasp 40. Once apertures 36 are cut and threads 12 attached, the pieces of material 34 are connected to form a cover 10 that easily slides over the hunting device 14. In one example, the cover 10 would have a front piece 42 that covered the front of the camera 14 attached to a second piece 44 that covers the sides, top, and back leaving an open bottom. Alternatively, the front, side, top, and back are attached to the hunting device 14.

It should be understood, of course, that the foregoing relates to exemplary embodiments of the invention and that modifications may be made without departing from the spirit and scope of the invention as set forth in the following claims.

What is claimed is:

1. A camouflage device, comprising;
a plurality of threads connected together to form a plurality of strips;
an attachment device for connecting the plurality of strips to a hunting device;
wherein the strips are attached to the hunting device in overlapping rows to substantially cover the hunting device.

2. The device of claim 1 wherein the attachment device is selected from a group consisting of glue, adhesive, elastic band, and a hook and loop fastener.

3. The device of claim 1 wherein the hunting device is a camera and the plurality of threads are cut to reveal a flash, a heat sensor, and a lens.

4. The device of claim 1 wherein the strips are attached to a substrate.

5. The device of claim 4 wherein the substrate is a net.

6. A camouflage device, comprising:
a plurality of threads attached to pieces of material that are cut to the size and shape to fit over a hunting device;
at least one aperture cut from the pieces of material that aligns with a feature of the hunting device when the pieces of material are placed over the hunting device;
wherein the pieces of material are connected together such that the connected pieces slide over the hunting device.

7. The device of claim 6 wherein the hunting device is a camera and apertures are cut from the pieces of material to align with a flash, a sensor, and a lens of the camera.
